(19) United States
(12) Patent Application Publication
(10) Pub. No.: US 2004/0221136 A1
(43) Pub. Date: Nov. 4, 2004

(54) Processor cluster

(76) Inventor: Paul Stravers, Eindhoven (NL)

Correspondence Address: Philips Electronics North America Corporation, Intellectual Property & Standards, M/S41-SJ, 1109 McKay Drive, San Jose, CA, 95131, US

(21) Appl. No.: 10/481,874

(22) PCT Filed: Jun. 20, 2002
(86) PCT No.: PCT/IB02/02371

(30) Foreign Application Priority Data
Jul. 7, 2001 (EP) 01202589.6

(51) Int. Cl. G06F 15/00

(52) U.S. Cl. 712/34

(57) ABSTRACT

A processor cluster according to the invention is implemented on a single integrated circuit comprising a configurable cache memory (1) and a plurality of processors (2a, . . . , 2e). At least two processors (2a, 2b) have mutually different instruction sets. The processor cluster further comprises a selection unit (6) for selectively activating one of the plurality of processors and giving said selected processor access to the cache memory.

The present invention relates to a processor cluster.

Embedded computer chips exhibit a trend, where with every new generation an ever growing percentage of the chip area is dedicated to memory, while an ever shrinking percentage of the chip area is dedicated to computational structures. This is based on the following observations. In the first place it has long been known that a balanced computer system is equipped with an amount of memory that is proportional to the computational power of the CPU (Central Processing Unit). As with each generation the maximum available clock frequency of a chip increases by 30%, the relative chip area dedicated to memory structures tends to increase by the same amount. As a concequence, memory eventually becomes the dominant resource that determines the production cost of the integrated circuit, while the compute logic in the processor or DSP core becomes relatively cheap.

It is a purpose of the invention to provide a processor cluster which on the one hand has a relatively wide applicability, and on the other hand can have a relatively limited amount of memory. For this purpose the processor cluster according to the invention is implemented on a single integrated circuit and comprises a configurable cache memory and a plurality of processors, at least two processors have mutually different instruction sets, the processor cluster further comprising a selection unit for selectively activating one of the plurality of processors and giving said selected processors access to the cache memory. The cache memory is a relatively fast memory for holding the most recently accessed code or data. According the principe of locality of reference the data or code most recently used is likely to be accessed again in the near future. Therefore the presence of a cache memory close to the processor cluster strongly improves the performance of the processor.

The processor cluster can be configured such that exactly one processor is activating and has a connection with the cache memory. The actual activation of said connection happens after the integrated circuit has been fabricated. On the one hand the possibility to select one out of a plurality of processors having a different instruction set enables the processor cluster to have a wide applicability. Because on the other hand only one cache memory is present on the integrated circuit, the integrated circuit can have a relatively limited amount of memory.

Field-programmable integrated circuits are known as such. However, the existing practice of providing a plurality of processor identities consists of combining a plurality of processors on an integrated circuit, where each processor has its own dedicated cache memory. As explained above, the technology trend makes memory resources more expensive while at the same time compute logic resource are becoming cheaper. In this context, the presented invention provides a cost-effective implementation of an integrated circuit with multiple types of mutually different processors.

It is remarked that EP 0 927 936 describes a processor structure comprising a microprocessor, a user configurable on-chip program memory and a controller for reconfiguring the memory. The microprocessor described therein is a VLIW processor which includes a plurality of execution units, such as a arithmetic+load/store unit, a multiplier, a arithmetic unit+shifter and a further arithmetic unit. The controller allows the memory to be mapped into internal address space in one mode, and to be configured as an on-chip cache in another mode. This document however, does not describe a configurable processor structure where the processor is assembled from individual units. Instead, in the processor cluster according to the invention a plurality of fixed unchangeable processor cores is connected through a field-programmable switch to a single cache memory.

It is further remarked that U.S. Pat. No. 5,937,203 describes a processor structure comprising tunable units (122A, . . . , 122N). Each tunable unit (122A, . . . , 122N) is connected to a respective memory (113A, . . . , 113N). Examples are a tunable pipeline, tunable ALU, tunable branch prediction unit, tunable multimedia execution unit and a tunable floating point unit. Tuning has as a result that a function is replaced by a comparable kind of function. For example a 16 bit adder is replaced by a 32 bit adder, or, a first kind of branch prediction is replaced by a second kind of branch prediction.

In the processor cluster according to the invention a different selection has as a result that a different processor having a different set of instructions is made available.

It is noted that U.S. Pat. No. 6,091,263 describes an FPGA comprising a first array of configurable logic blocks (CLBs) and a second array of CLBs. The first array of CLBs is coupled to a corresponding first configuration cache memory array. The first configuration cache memory array stores values for reconfiguring the first array of CLBs. The second array of CLBs is coupled to a corresponding second configuration cache memory array. The second configuration cache memory array stores values for reconfiguring the second array of CLBs. Said FPGA requires a reduced amount of routing resources for reconfiguring the FPGA.

For the sake of completeness it is remarked that EP 668 659 A2 describes a reconfigurable semi-conductor integrated circuit. The circuit comprises a plurality of cells which have two or more configurations, each configuration being defined by the cell function and/or its interconnection with other cells.

In an embodiment of the processor cluster according to the invention the plurality of processors include at least a microcontroller and a digital signal processor (DSP). Microcontrollers such as MIPS and ARM typically provide an instruction set architecture (ISA) that is optimised for control processing. This means their ISA is optimised to execute programs that collect data from various places in the computer memory, compare these data items to each other and to constant data, and then take decisions based on the outcome of these comparisons. In other words, processors with such ISAs are preferably selected to execute the typical “load, compare, branch” structure of control intensive programs. DSPs such as OAK, PALM, REAL, and Trimedia typically provide an ISA that is optimised for signal processing. This means their ISA is optimised to execute programs that perform the same set of arithmetic operations repeatedly on the consecutive members of a data block in the computer memory. Usually these programs are very compute intensive, executing many arithmetic operations including many multiplications, often combined with saturating additions.

In an embodiment the processor cluster may contain different types of microcontrollers. Even though both MIPS and ARM are optimised for control processing, their instruction sets different in several aspects. For example, the ARM provides 16 general purpose registers to the programmer, where the MIPS provides 31 such registers. Both ISAs provide instructions that offer the same functionality (such as “add” or “branch if zero”) but the way that these instructions are encoded by the ISA is different, making it impossible for a MIPS to execute ARM instructions or the other way around. Furthermore, MIPS and ARM take a different approach to conditional execution: ARM provides branches instructions and guarded instructions, while MIPS only provides branches.

An embodiment of the processor cluster may contain different types of digital signal processors. Also among DSPs significant differences can be found in their approach to signal processing. For example, a REAL DSP targets applications such as audio processing that require medium performance levels, while Trimedia targets applications such as video and graphics processing that require much higher performance levels. This difference is reflected in the respective ISAs of these DSPs. For this reason it is impossible for a REAL to execute Trimedia instructions and the other way around, even though both belong to the DSP family of processors.

The cache may be managed either by software or by hardware control. A processor with a hardware controlled cache is relatively easy to program, but the programmer has little or no control over the cache mangement. Software control has the advantage that the programmer may control exactly what data is remained in cache, and what will be replaced by new data. A disadvantage however, is that a processor with a software controlled cache is more difficult to program.

In a preferred embodiment of the processor cluster according to the invention, the cache memory is configurable as a DSP instruction memory bank and as a DSP data memory bank, according to the DSPs in the processor cluster.

Hence also the presence of different processors of the same type in the processor cluster provides for an increased flexibility of use.

Several processor clusters may be integrated in a processing system. In such a system, preferably the cache memory is configurable to support cache coherence protocols for supporting system-level cache coherence. This makes it possible to achieve cache coherence between the different processor clusters in the system.

These and other aspects of the invention, are described in more detail with reference to the drawings. Therein

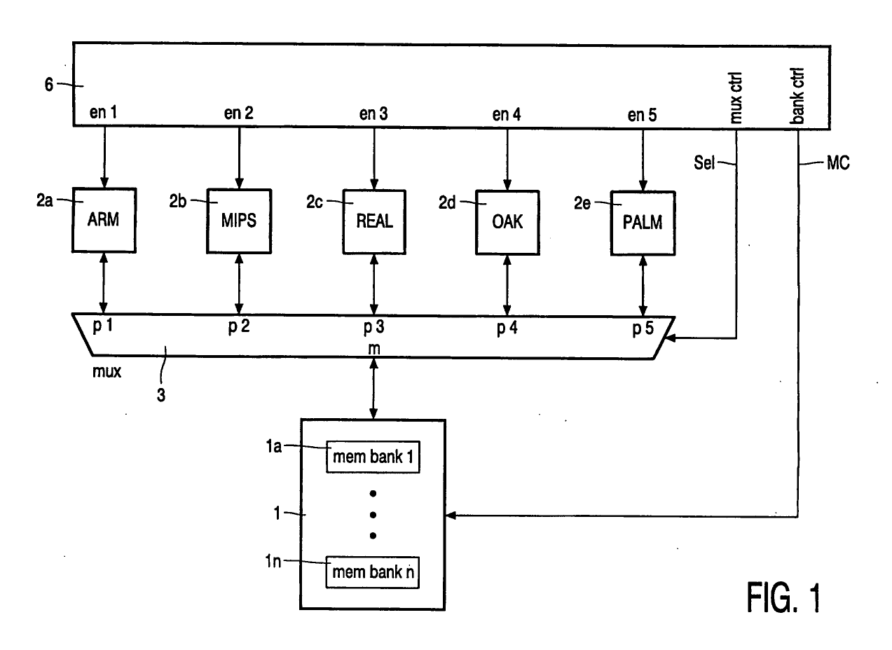

FIG. 1 schematically shows a first embodiment of a processor cluster according to the invention,

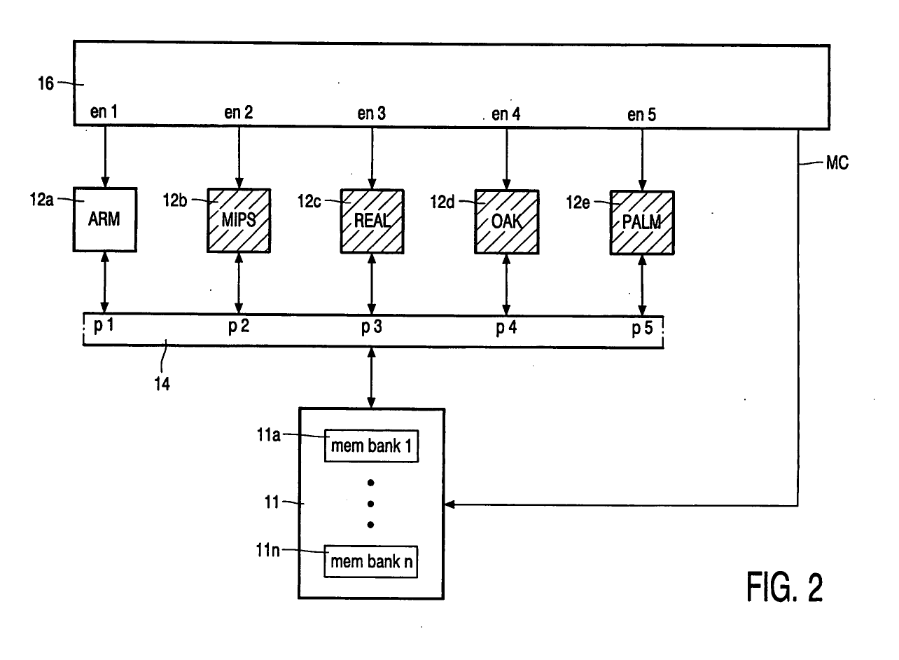

FIG. 2 shows a second embodiment.

FIG. 1 schematically shows a processor cluster implemented on a single integrated circuit comprising a cache memory 1 including a plurality of memory banks 1a, . . . , 1n and a cache control unit. The processor cluster further comprises a plurality of processors 2a, . . . , 2e. In the example depicted in FIG. 1 the plurality of processors include a first 2a and a second micro-controller 2b, and a first 2c, a second 2d and a third signal processor 2e. The two microcontrollers 2a, 2b differ from each other in that they have mutually different instruction sets. In the embodiment shown the first microcontroller 2a is an ARM and the second microcontroller is a MIPS. The three digital signal processors 2c, 2d, 2e also have different instruction sets. In casu the three DSPs include a REAL 2c, an OAK 2d and a PALM 2e. The processor cluster further comprises a selection unit 6 for selectively activating one or more of the plurality of processors 2a, . . . , 2c and giving said selected processors access to the cache memory 1.

Only one of the processors 2a, . . . , 2e can be activated (i.e. connected to the cache memory). The selection unit 6 selects said processor by providing an enable signal en1, . . . , en5 to said processor, e.g. enable signal en3 if the digital signal processor 2c is to be activated. The other processors are deactivated and hence do not need to consume significant amounts of energy. In the embodiment shown, the selected processor, e.g. the DSP 2c is granted access to the cache memory 1 via a multiplexer 3, which is controlled by a control signal Sel from the selection unit 6. In an other embodiment the processors may be connected via tristate gates to the cache memory 1, which are selectively enabled by the selection unit 6. Furthermore, the exact configuration of the memory banks 1a. . . , 1n is controlled by a signal MC. The latter allows the different processors 2a, . . . , 2e to have different cache configurations so as to perform in accordance with their respective ISAs.

FIG. 2 shows another embodiment. In FIG. 2 parts corresponding to those of FIG. 1 have a reference number which is 10 higher. In this embodiment the multiplexer 3 of FIG. 1 is replaced by a bus 14. Via this bus 14 the selected processors, here the ARM processor 12a communicates with the cache memory 11. The processors 12b, 12c, 12d and 12e, shown dashed, are deactivated. Hence these processors will not access the cache memory 11.

The selection can take place by the user, for example at start up of a system comprising the invention. Otherwise, the selection may take place by the manufacturer, dependent of the application for which the processor cluster is to be used.

It is possible to disconnect the cache memory from the currently active core and then reconnect the cache memory to one of the other cores in the set, but this is usally a rather complex operation, involving a properly executed shutdown program on the current core, followed by the actual switching under control of the selection unit 6, and then followed by a properly executed boot program on the new core. Therefore, reallocation of the cache memory from one core to another is possible with a frequency that is typically at least several orders of magnitude lower than the frequency at which the cores execute their instructions.

It is remarked that the scope of protection of the invention is not restricted to the embodiments described herein. Neither is the scope of protection of the invention restricted by the reference numerals in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general purpose processor. The invention resides in each new feature or combination of features

1. Processor cluster implemented on a single integrated circuit comprising a configurable cache memory (1) and a plurality of processors (2a, . . . , 2e), at least two processors (2a, 2b) have mutually different instruction sets, the processor cluster further comprising a selection unit (6) for selectively activating one of the plurality of processors and giving said selected processor access to the cache memory.

2. The processor cluster according to claim 1, characterized in that the plurality of processors include at least a microcontroller (2a, 2b) and a digital signal processor (2c, 2d, 2e).

3. The processor cluster according to claim 1, characterized in that the digital signal processor is a programmable DSP core (2c, 2d, 2e).

4. The processor cluster according to claim 1, characterized in that the cache memory is configurable as a DSP instruction memory bank and as a DSP data memory bank, according to the DSPs in the processor cluster.

5. The processor cluster according to claim 1, characterized in that the cache memory is configurable to support cache coherence protocols for supporting system-level cache coherence.
